(19) United States
(12) Patent Application Publication
(10) Pub. No.: US 2026/0152171 A1
(43) Pub. Date: Jun. 4, 2026

(54) HYBRID ELECTRIC VEHICLE

(71) Applicant: TOYOTA JIDOSHA KABUSHIKI KAISHA, Toyota-shi (JP)

(72) Inventor: Takeo SEGAWA, Toyota-shi (JP)

(73) Assignee: TOYOTA JIDOSHA KABUSHIKI KAISHA, Toyota-shi (JP)

(21) Appl. No.: 19/398,151

(22) Filed: Nov. 24, 2025

(30) Foreign Application Priority Data
Nov. 29, 2024 (JP) 2024-208916

(51) Int. Cl. B60W 20/15; B60K 6/26; B60K 6/36; B60K 6/40; B60W 10/08

(52) U.S. Cl. CPC B60W 20/15; B60K 6/26; B60K 6/36; B60K 6/40; B60W 10/08; B60W 2510/0695; B60W 2510/1005; B60W 2510/12; B60W 2530/10; B60W 2530/20; B60W 2710/083; B60Y 2200/92; B60Y 2400/80

(57) ABSTRACT

A hybrid electric vehicle includes an engine, a first motor connected to the engine, a transmission connected to the first motor and to a transfer shaft linked to drive wheels, a second motor connected to the transfer shaft, and a controller. The controller controls the first and second motors such that, when the vehicle accelerates after decelerating, backlash take-up of a downstream coupling, which is a coupling located on the drive wheels side relative to the transfer shaft, is performed using torque from the second motor, and backlash take-up of an upstream coupling, which is a coupling located on the engine side relative to the transfer shaft, is performed using torque from the first motor.

### CROSS-REFERENCE TO RELATED APPLICATIONS

The present disclosure claims priority to Japanese Patent Application No. 2024-208916 filed Nov. 29, 2024, which is incorporated herein by reference in its entirety including specification, drawings and claims.

### TECHNICAL FIELD

The present disclosure relates to a hybrid electric vehicle.

### BACKGROUND

Conventionally, a technique has been proposed in which, when a controller determines that an effective torque, obtained by subtracting a drag torque from a motor torque, enters or exits a zero-torque region of a gear backlash mechanism, the controller initiates control to limit the effective torque to a parabolic-shaped or exponentially-shaped torque (see, for example, Japanese Patent Application Laid Open No. 2010-215213).

### SUMMARY

A hybrid electric vehicle has also been devised, including an engine, a first motor connected to the engine, a transmission connected to the first motor and to a transfer shaft linked to the drive wheels, and a second motor connected to the transfer shaft. In such a hardware configuration, when the vehicle accelerates after decelerating, in some cases, a certain amount of time is required for torque from the engine to increase to a predetermined magnitude. Accordingly, if backlash take-up of a downstream coupling, which is a coupling located on the drive wheels side relative to the transfer shaft, is performed using torque from the second motor, and then backlash take-up of an upstream coupling, which is a coupling located on the engine side relative to the transfer shaft, is performed using torque from the engine, shocks and gear rattling noises accompanying the backlash take-up of the downstream coupling may occur first, followed by shocks and gear rattling noises accompanying the backlash take-up of the upstream coupling after a certain delay.

The main objective of the hybrid electric vehicle according to the present disclosure is to suppress the occurrence of shocks and gear rattling noises accompanying the backlash take-up of the upstream coupling, after a certain delay following the occurrence of shocks and gear rattling noises accompanying the backlash take-up of the downstream coupling when the vehicle accelerates after decelerating.

In order to achieve the above main object, the hybrid electric vehicle according to the present disclosure employs the following configuration.

A hybrid electric vehicle according to the present disclosure is a hybrid electric vehicle includes: an engine; a first motor connected to the engine; a transmission connected to the first motor and to a transfer shaft linked to drive wheels; a second motor connected to the transfer shaft; and a controller. The controller is programmed to control the first and second motors such that, when the vehicle accelerates after decelerating, backlash take-up of a downstream coupling, which is a coupling located on the drive wheels side relative to the transfer shaft, is performed using torque from the second motor, and backlash take-up of an upstream coupling, which is a coupling located on the engine side relative to the transfer shaft, is performed using torque from the first motor.

The hybrid electric vehicle controls the first and second motors such that, when the vehicle accelerates after decelerating, backlash take-up of a downstream coupling, which is a coupling located on the drive wheels side relative to the transfer shaft, is performed using torque from the second motor, and backlash take-up of an upstream coupling, which is a coupling located on the engine side relative to the transfer shaft, is performed using torque from the first motor. By performing the backlash take-up of the upstream coupling using torque from the first motor, the backlash take-up of the upstream coupling can be completed at an earlier timing compared to performing the backlash take-up of the upstream coupling using torque from the engine. As a result, the occurrence of shocks and gear rattling noises accompanying the backlash take-up of the upstream coupling, after a certain delay following the occurrence of shocks and gear rattling noises accompanying the backlash take-up of the downstream coupling, can be suppressed. Accordingly, shocks and gear rattling noises accompanying such backlash take-up can be suppressed from being felt by the driver twice with a time interval.

### BRIEF DESCRIPTION OF DRAWINGS

FIG. 1 is a schematic diagram schematically illustrating a hybrid electric vehicle according to an embodiment of the present disclosure;

FIG. 2 is a flowchart illustrating an example of a processing routine;

FIG. 3 is an explanatory diagram illustrating an example of the vehicle behavior when accelerating after deceleration in a comparative example;

FIG. 4(A) is an explanatory diagram illustrating an example of the vehicle behavior when accelerating after deceleration in the same comparative example;

FIG. 4(B) is an explanatory diagram illustrating an example of the vehicle behavior when accelerating after deceleration in the same comparative example;

FIG. 4(C) is an explanatory diagram illustrating an example of the vehicle behavior when accelerating after deceleration in the same comparative example;

FIG. 5 is an explanatory diagram illustrating an example of the vehicle behavior when accelerating after deceleration in the embodiment;

FIG. 6(A) is an explanatory diagram illustrating an example of the vehicle behavior when accelerating after deceleration in the embodiment, and

FIG. 6(B) is an explanatory diagram illustrating an example of the vehicle behavior when accelerating after deceleration in the embodiment.

### DESCRIPTION OF EMBODIMENTS

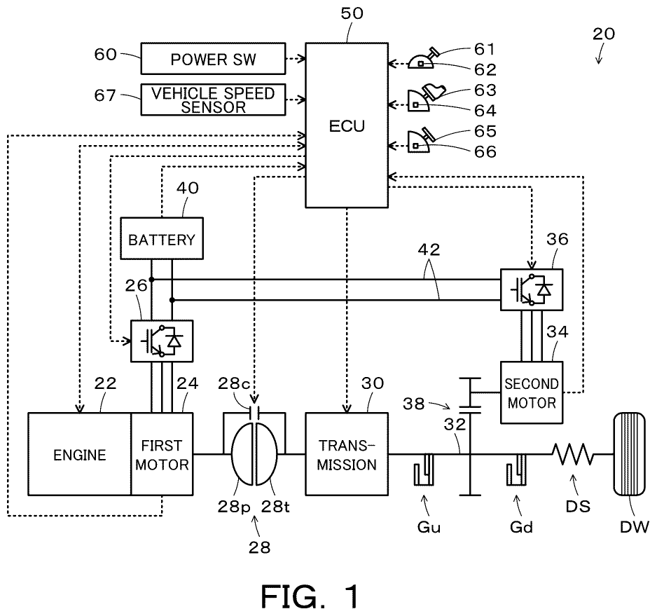

The embodiments for carrying out the present disclosure will be described with reference to the drawings. FIG. 1 is a schematic diagram schematically illustrating a hybrid electric vehicle 20 according to an embodiment of the present disclosure. As illustrated, the hybrid electric vehicle 20 of the embodiment includes an engine 22, a first motor 24, a first inverter 26, a torque converter 28, a transmission 30, a second motor 34, a second inverter 36, a battery 40, and an electronic control unit (hereinafter referred to as “ECU”) 50.

The engine 22 is configured as an internal combustion engine that outputs power using a hydrocarbon-based fuel such as gasoline or diesel from a fuel tank. The engine 22 includes a throttle valve, an intake valve, an exhaust valve, a fuel injection valve, and an ignition plug. The first motor 24 is configured as a synchronous generator motor. The first motor 24 includes a rotor, in which permanent magnets are embedded in a rotor core and which is attached to a rotating shaft, and a stator in which a three-phase coil is wound around a stator core. A crankshaft of the engine 22 and the rotating shaft of the first motor 24 are directly connected to each other. The first inverter 26 has a plurality of switching elements. By switching the plurality of switching elements of the first inverter 26, the first motor 24 is rotationally driven. The first inverter 26 is connected to a power line 42.

The torque converter 28 is configured as a general fluid transmission device. The torque converter 28 includes a pump impeller 28p, a turbine runner 28t, a stator, and a hydraulically actuated lock-up clutch 28c. The pump impeller 28p is connected to the rotating shaft of the first motor 24. The turbine runner 28t is connected to an input shaft of the transmission 30. The stator rectifies a flow of working oil from the turbine runner 28t to the pump impeller 28p. The lock-up clutch 28c connects and disconnects the pump impeller 28p (the rotating shaft of the first motor 24) and the turbine runner 28t (the input shaft of the transmission 30). The torque converter 28 transmits power from the engine 22 and/or the first motor 24 to the input shaft of the transmission 30 with or without torque amplification.

The transmission 30 includes an input shaft, an output shaft, at least one planetary gear mechanism, and a plurality of hydraulically actuated friction engagement elements (at least one clutch and at least one brake). The input shaft is connected to the torque converter 28. The output shaft is connected to a transfer shaft 32. The transfer shaft 32 is connected to drive wheels DW via a drive shaft DS and a differential gear. The transmission 30 forms a plurality of forward gears and at least one reverse gear by engaging and releasing the plurality of friction engagement elements, and transmits power between the input shaft and the output shaft.

The second motor 34 is configured as a synchronous generator motor, similarly to the first motor 24, and includes a rotor and a stator. The second motor 34 is connected to the transfer shaft 32 via a gear mechanism 38. The second inverter 36 has a plurality of switching elements, similarly to the first inverter 26. By switching the plurality of switching elements of the second inverter 36, the second motor 34 is rotationally driven. The second inverter 36 is connected to the power line 42, similarly to the first inverter 26.

In FIG. 1, the upstream coupling Gu schematically illustrates, as a single unit, each mechanical coupling on the engine 22 side relative to the transfer shaft 32, and the downstream coupling Gd schematically illustrates, as a single unit, each mechanical coupling on the drive wheels DW side relative to the transfer shaft 32. Here, each mechanical coupling includes a gear meshing section, a spline fitting section, and the like. In FIG. 1, the upstream coupling Gu and the downstream coupling Gd are shown in a state in which they are tightly engaged on the driving side of the vehicle.

The battery 40 is configured, for example, as a lithium-ion secondary battery or a nickel-metal hydride secondary battery. The battery 40 is connected to the power line 42 together with the first and second inverters 26 and 36.

The ECU 50 includes a microcomputer, various drive circuits, and various logic ICs. The microcomputer has a CPU, ROM, RAM, flash memory, input/output ports, and communication ports. The ECU 50 receives signals from various sensors. For example, the ECU 50 receives a crank angle θcr of the crankshaft of the engine 22 from a crank angle sensor, and rotation positions θm1 and θm2 of the rotors of the first and second motors 24 and 34 from rotation position sensors. The ECU 50 also receives a voltage Vb of the battery 40 from a voltage sensor and a current Ib of the battery 40 from a current sensor. Furthermore, the ECU 50 receives an on/off signal from a power switch 60, a shift position SP representing an operation position of a shift lever 61 from a shift position sensor 62, an accelerator opening Acc representing a depression amount of an accelerator pedal 63 from an accelerator pedal position sensor 64, a brake pedal position BP representing a depression amount of a brake pedal 65 from a brake pedal position sensor 66, and a vehicle speed V from a vehicle speed sensor 67.

The ECU 50 outputs various control signals. For example, the ECU 50 outputs control signals to the engine 22, the first and second inverters 26 and 36, the lock-up clutch of the torque converter 28, and the transmission 30. The ECU 50 calculates a rotational speed Ne of the engine 22 based on the crank angle θcr of the engine 22. The ECU 50 calculates rotational speeds Nm1 and Nm2 of the first and second motors 24 and 34 based on the rotation positions θm1 and θm2 of the rotors of the first and second motors 24 and 34. The ECU 50 calculates a state of charge SOC of the battery 40 based on an integrated value of the current Ib of the battery 40.

The hybrid electric vehicle 20 of the embodiment travels by selecting a travel mode from a plurality of modes, for example, a first, second, and third mode. In the first, second, and third modes, the ECU 50 sets a requested torque Td* for travel (to the drive wheels DW) based on the accelerator opening Acc and the vehicle speed V. In the first mode, the ECU 50 controls the engine 22, the first and second motors 24 and 34 (the first and second inverters 26 and 36), the torque converter 28 (lock-up clutch), and the transmission 30 such that the vehicle travels with operation of the engine 22 according to the requested torque Td*. In the second mode, the ECU 50 controls the second motor 34 (the second inverter 36) such that the vehicle travels according to the requested torque Td* with the engine 22 stopped. In the third mode, the ECU 50 controls the first and second motors 24 and 34 (the first and second inverters 26 and 36), the torque converter 28 (lock-up clutch), and the transmission 30 such that the vehicle travels according to the requested torque Td* with the engine 22 stopped.

Next, the operation of the hybrid electric vehicle 20 according to the embodiment, and particularly the control of the first and second motors 24 and 26 (the first and second inverters 26 and 36) when the vehicle accelerates after decelerating, will be described. In the embodiment, during vehicle deceleration with the accelerator released, the ECU 50 controls the engine 22 such that the engine 22 performs self-sustained operation or undergoes fuel cut, controls the second inverter 36 such that the second motor 34 operates in regenerative mode, and controls the lock-up clutch of the torque converter 28 such that the lock-up clutch is released. When the accelerator is depressed during vehicle deceleration and the vehicle accelerates, the ECU 50 controls the engine 22 such that the torque from the engine 22 approaches a target torque based on the requested torque Td*. However, in some cases, a certain amount of time is required for the torque from the engine 22 to increase to a certain magnitude (i.e., to a level at which the torque from the engine 22 is used for vehicle travel. Control of the first and second motors 24 and 26 (the first and second inverters 26 and 36) during the period from when the accelerator is depressed during vehicle deceleration to when the torque from the engine 22 reaches the predetermined magnitude will be described below. In addition, when the accelerator is depressed during vehicle deceleration and the vehicle accelerates, backlash take-up of the upstream coupling Gu and downstream coupling Gd occurs from the vehicle's braking side to the vehicle's drive side.

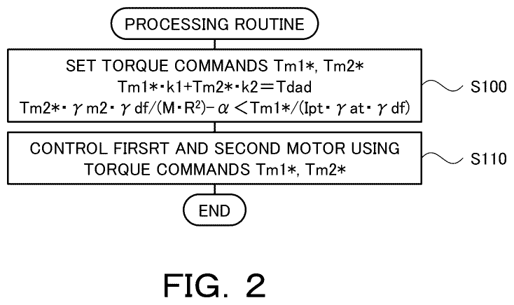

FIG. 2 is a flowchart illustrating an example of a processing routine executed by the ECU 50. This routine is repeatedly executed for controlling the first and second motors 24 and 26 (the first and second inverters 26 and 36) during the period from when the accelerator is depressed during vehicle deceleration to when the torque from the engine 22 increases to a certain magnitude.

When this routine is executed, the ECU 50 sets torque commands Tm1* and Tm2* for the first and second motors 24 and 34 to satisfy equations (1) and (2) (Step S100). Subsequently, the ECU 50 controls the first and second inverters 26 and 36 using the torque commands Tm1* and Tm2* for the first and second motors 24 and 34 (Step S110), and the routine ends.

Here, equation (1) is represented using the adjusted torque Tdad based on the requested torque Td*, the torque commands Tm1* and Tm2* for the first and second motors 24 and 34, and conversion coefficients k1 and k2. The adjusted torque Tdad is, for example, obtained by applying a smoothing process to the requested torque Td*. The conversion coefficients k1 and k2 are coefficients for converting the torque of the first and second motors 24 and 34 into torque acting on the drive wheels DW, respectively.

Equation (2) is represented using vehicle mass M, a tire dynamic radius R of the drive wheels DW, equivalent inertia Ipt from the engine 22 to the transmission 30, gear ratio γm2 between the second motor 34 and the transfer shaft 32, gear ratio γdf of the differential gear connected to the transfer shaft 32 and the drive shaft DS linked to the drive wheels DW, gear ratio γat corresponding to the transmission stage Gs of the transmission 30, and an allowable amount α. The vehicle mass M is a mass acting on the drive wheels DW. The vehicle mass M, the tire dynamic radius R, the equivalent inertia Ipt, the gear ratio γm2, and the gear ratio γdf are, for example, predetermined as specifications of the vehicle. The allowable amount α is predetermined such that a delay time between the timing of completion of backlash take-up of the upstream coupling Gu on the vehicle's drive side and the timing of completion of backlash take-up of the downstream coupling Gd on the vehicle's drive side is less than or equal to the allowable time. The allowable time is predetermined, for example, by experiments or analyses, such that shocks and gear rattling noises accompanying the backlash take-up can be suppressed from being felt by the driver twice with a time interval (while allowing the driver to feel them only once). When the torque commands Tm1* and Tm2* for the first and second motors 24 are set such that the portion excluding “−α” on the left side of equation (2) is equal to the right side of equation (2), the timing of completion of the backlash take-up of the downstream coupling Gd and the timing of completion of the backlash take-up of the upstream coupling Gu are assumed to be substantially the same.

$$Tm 1 * ▯ k 1 + Tm 2 * ▯ k 2 = Tdad \qquad ( 1 )$$

$$Tm 2 * ▯ ym 2 ▯ ydf / ( M ▯ R 2 ) - α < Tm 1 * / ( Ipt ▯ yat ▯ ydf ) \qquad ( 2 )$$

By setting the torque commands Tm1* and Tm2* for the first and second motors 24 and 34 to satisfy equations (1) and (2) and controlling the first and second inverters 26 and 36, the delay time of the timing of completion of the backlash take-up of the upstream coupling Gu on the vehicle's drive side relative to the timing of completion of the backlash take-up of the downstream coupling Gd on the vehicle's drive side can be suppressed from becoming relatively long. When the torque from the engine 22 increases to a certain magnitude (i.e., to a level at which the torque from the engine 22 is used for vehicle travel), the ECU 50 sets the torque commands Tm1* and Tm2* for the first and second motors 24 and 34 and controls the first and second inverters 26 and 36 such that the torque from the first and second motors 24 and 34 gradually decreases in accordance with the increase in the torque from the engine 22.

Here, in order to facilitate understanding of the present disclosure, a comparative example and the embodiment will be described in this order. In the comparative example, when the vehicle accelerates after decelerating, the first motor 24 does not to output torque to the vehicle's drive side until the torque from the engine 22 increases to a certain magnitude (i.e., to a level at which the torque from the engine 22 is used for vehicle travel). That is, the ECU 50 sets the torque command Tm1* of the first motor 24 to a value of zero and control the first inverter 26. Accordingly, the backlash take-up of the downstream coupling Gd on the vehicle's drive side is performed using the torque from the engine 22.

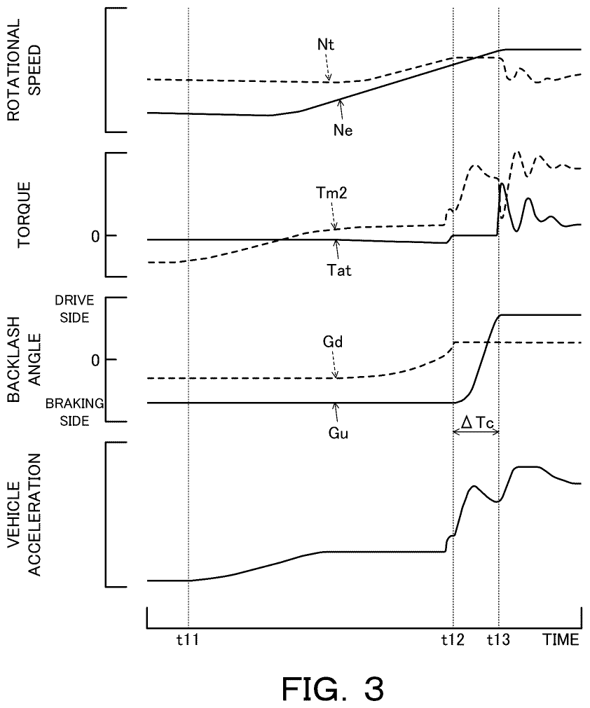

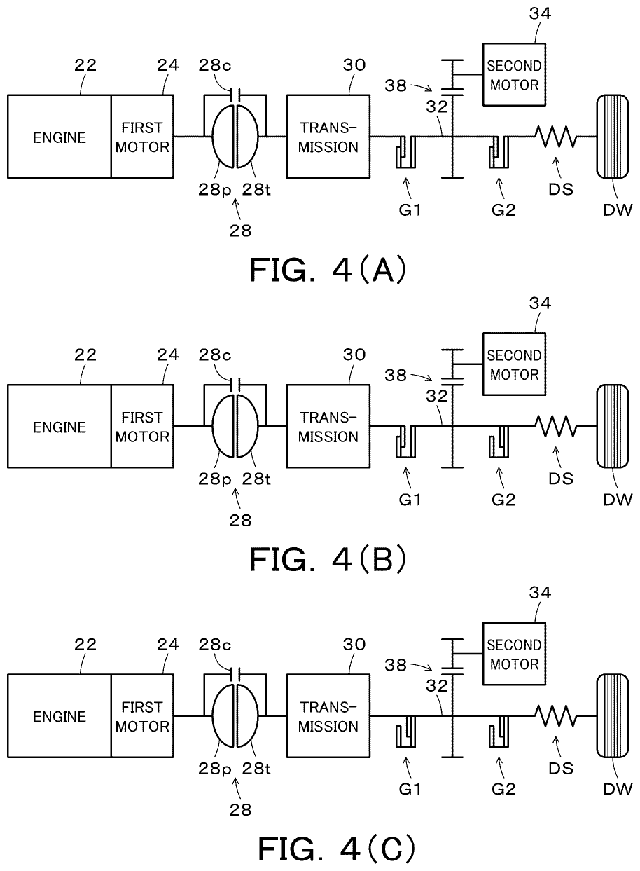

FIGS. 3 and 4 are explanatory diagrams illustrating an example of the vehicle behavior when accelerating after deceleration in the comparative example. FIG. 3 shows the rotational speed Ne of the engine 22, the rotational speed Nt of the turbine runner 28t of the torque converter 28, the torque Tat of the output shaft of the transmission 30, the torque Tm2 of the second motor 34, backlash angles of the upstream coupling Gu and the downstream coupling Gd, and the vehicle acceleration. Here, the backlash angles of the upstream coupling Gu and the downstream coupling Gd are the sums of the backlash angles of the respective mechanical couplings of the upstream coupling Gu and the downstream coupling Gd, respectively. FIG. 4 shows the manner of the backlash take-up of the upstream coupling Gu and the downstream coupling Gd.

In the comparative example, during vehicle deceleration, as shown prior to time t11 in FIG. 3, backlash take-up of the upstream coupling Gu and the downstream coupling Gd is toward the vehicle's braking side (see FIG. 4(A)). When the accelerator is depressed at time t11 from this state, the torque Tm2 from the second motor 34 gradually increases, crosses zero, and becomes positive. Using this torque, backlash take-up of the gear mechanism 38 and the downstream coupling Gd occurs from the vehicle's braking side toward the vehicle's drive side, and this backlash take-up is completed at time t12 (see FIG. 4(B)). Meanwhile, the rotational speed Ne of the engine 22 gradually increases. Thereafter, when the torque from the engine 22 becomes large, backlash take-up of the upstream coupling Gu occurs from the vehicle's braking side toward the vehicle's drive side, and this backlash take-up is completed at time t13 (see FIG. 4(C)). In the figure, “ΔTc” indicates the delay time of the completion of the backlash take-up of the upstream coupling Gu at time t13 relative to the completion of the backlash take-up of the downstream coupling Gd at time t12 in the comparative example. As can be seen from FIG. 3, in the comparative example, shocks and gear rattling noises accompanying the backlash take-up of the upstream coupling Gu may occur after a certain delay following shocks and gear rattling noises accompanying the backlash take-up of the downstream coupling Gd. That is, in the comparative example, the delay time ΔTc becomes relatively long, and the driver may feel shocks and gear rattling noises twice at separate times.

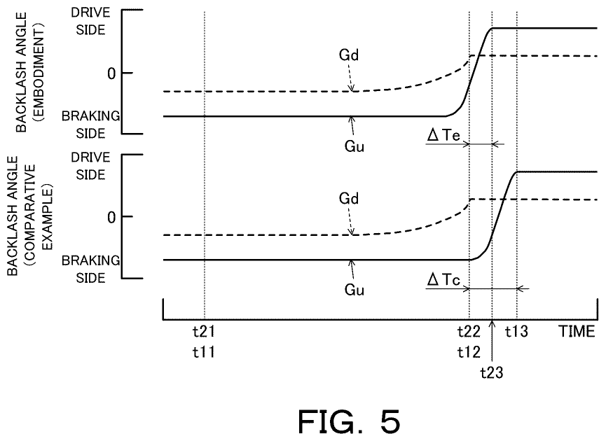

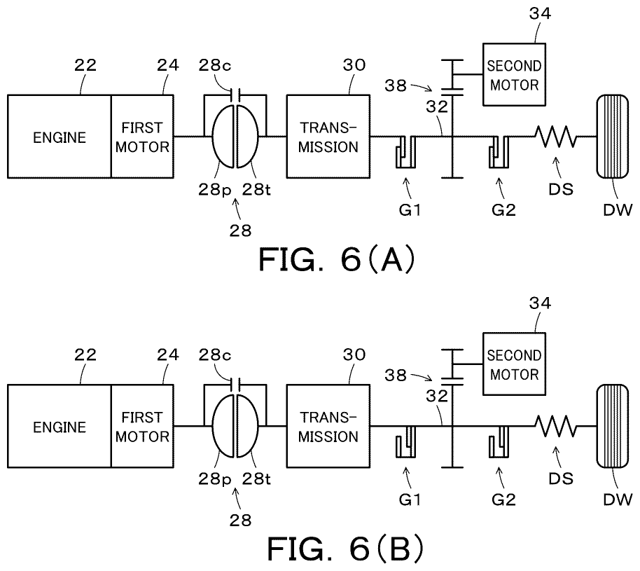

Next, the embodiment will be described. FIGS. 5 and 6 are explanatory diagrams illustrating an example of the vehicle behavior when accelerating after deceleration in the embodiment. FIG. 5 shows the backlash angles of the upstream coupling Gu and the downstream coupling Gd. In FIG. 5, the backlash angles of the upstream coupling Gu and the downstream coupling Gd in the comparative example (the same as in FIG. 3) are also illustrated. In FIG. 5, times t11 to t13 correspond to those in FIG. 3. FIG. 6 shows the manner of backlash take-up of the upstream coupling Gu and the downstream coupling Gd.

In the embodiment, during vehicle deceleration, as shown prior to time t21 in FIG. 5, backlash take-up of both the upstream coupling Gu and the downstream coupling Gd is toward the vehicle's braking side (see FIG. 6(A)). When the accelerator is depressed at time t21 from this state, using the torque from the second motor 34, the backlash take-up of the downstream coupling Gd occurs from the vehicle's braking side toward the vehicle's drive side, and the backlash take-up of the upstream coupling Gu occurs from the vehicle's braking side toward the vehicle's drive side. Accordingly, the backlash take-up of the downstream coupling Gd is completed at time t22, the backlash take-up of the upstream coupling Gu is completed at time t23 (see FIG. 6(B)). In the figure, “ΔTe” indicates the delay time of the completion of the backlash take-up of the upstream coupling Gu at time t23 relative to the completion of the backlash take-up of the downstream coupling Gd at time t22 in the embodiment. By performing the backlash take-up of the upstream coupling Gu using the torque from the first motor 24, the backlash take-up of the upstream coupling Gu can be completed at an earlier timing compared to performing the backlash take-up of the upstream coupling Gu using the torque from the engine 22. As a result, the occurrence of shocks and gear rattling noises accompanying the backlash take-up of the upstream coupling Gu, after a certain delay following the occurrence of shocks and gear rattling noises accompanying the backlash take-up of the downstream coupling Gd, can be suppressed. That is, in the embodiment, the delay time ΔTe can be made shorter than the delay time ΔTc in the comparative example, thereby suppressing the driver from feeling shocks and gear rattling noises accompanying backlash take-up twice with a time interval.

Moreover, in the embodiment, the ECU 50 sets the torque commands Tm1* and Tm2* for the first and second motors 24 and 34 and controls the first and second motors 24 and 34 (the first and second inverters 26 and 36) to satisfy the equation (2) described above. As a result, the delay time ΔTe can be kept below the allowable time described above.

In a case where the ECU 50 sets the torque commands Tm1* and Tm2* for the first and second motors 24 and 34 to satisfy equation (2), when the torque command Tm1* is made relatively large and the torque command Tm2* is made relatively small, there is a possibility that the completion timing of the backlash take-up of the upstream coupling Gu becomes earlier than the completion timing of the backlash take-up of the downstream coupling Gd. In this case, after completion of the backlash take-up of the upstream coupling Gu, the backlash take-up of the downstream coupling Gd is performed using torque from both the first and the second motors 24 and 34. Therefore, it is considered that the possibility of a time interval between the completion timing of the backlash take-up of the upstream coupling Gu and the completion timing of the backlash take-up of the downstream coupling Gd becoming relatively long is low.

As described above, when the vehicle accelerates after decelerating, the hybrid electric vehicle 20 of the embodiment sets the torque commands Tm1* and Tm2* for the first and second motors 24 and 34 such that the backlash take-up of the downstream coupling Gd is performed using the torque from the second motor 34, and the backlash take-up of the upstream coupling Gu is performed using the torque from the first motor 24, and controls the first and second inverters 26 and 36. By performing the backlash take-up of the upstream coupling Gu using the torque from the first motor 24, the backlash take-up of the upstream coupling Gu can be completed at an earlier timing compared to performing the backlash take-up of the upstream coupling Gu using the torque from the engine 22. As a result, the occurrence of shocks and gear rattling noises accompanying the backlash take-up of the upstream coupling Gu, after a certain delay following the occurrence of shocks and gear rattling noises accompanying the backlash take-up of the downstream coupling Gd, can be suppressed. Accordingly, shocks and gear rattling noises accompanying such backlash take-up can be suppressed from being felt by the driver twice with a time interval.

In the embodiment described above, when the vehicle accelerates after decelerating, the ECU 50 sets the torque commands Tm1* and Tm2* for the first and second motors 24 and 34 to satisfy equation (2) and controls the first and second inverters 26 and 36. However, the present disclosure is not limited to this configuration. When the vehicle accelerates after decelerating, the ECU 50 only needs to set the torque commands Tm1* and Tm2* for the first and second motors 24 and 34 such that the backlash take-up of the downstream coupling Gd is performed using the torque from the second motor, and the backlash take-up of the upstream coupling Gu is performed using the torque from the first motor, and controls the first and second inverters 26 and 36.

In the embodiment, the second motor 34 is connected to the transfer shaft 32 via the gear mechanism 38. However, the present disclosure is not limited to this configuration. For example, the second motor 34 may be directly connected to the transfer shaft 32.

In the hybrid electric vehicle according to the present disclosure, the second motor may be connected to the transfer shaft via a gear mechanism, and the controller, with torque commands of the first and second motors being Tm1* and Tm2*, respectively; vehicle mass being M; a dynamic tire radius of the drive wheels being R; equivalent inertia from the engine to the transmission being Ipt; gear ratio between the second motor and the transfer shaft being γm2; gear ratio of a differential gear connected to the transfer shaft and the drive wheels being γdf; gear ratio of the transmission being γat; and an allowable amount being α, may be programmed to set the torque commands Tm1* and Tm2* to satisfy equation (A) and to control the first and second motors.

$$T m {2}^{⋆} ▯ ym 2 ▯ ydf / ( M ▯ R 2 ) - α < Tm {1}^{⋆} / ( Ipt ▯ yat ▯ ydf ) \qquad ( A )$$

In the hybrid electric vehicle according to the present disclosure, the allowable amount α may be determined such that a delay time between the timing of completion of the backlash take-up of the upstream coupling and the timing of completion of the backlash take-up of the downstream coupling is less than or equal to the allowable time.

The correspondence between the main elements of the embodiment and the main elements of the disclosure described in Summary is explained as follows. In the embodiment, an engine 22 corresponds to the “engine”, a first motor 24 corresponds to the “first motor”, a transmission 30 corresponds to the “transmission”, a second motor 34 corresponds to the “second motor”, and an ECU 50 corresponds to the “controller”.

The correspondence relationship between the primary elements of the embodiment and the primary elements of the disclosure, regarding which the problem is described in the Summary, should not be considered to limit the elements of the disclosure, regarding which the problem is described in the Summary, since the embodiment is only illustrative to specifically describes the aspects of the disclosure, regarding which the problem is described in the Summary. In other words, the disclosure, regarding which the problem is described in the Summary, should be interpreted on the basis of the description in the Summary, and the embodiment is only a specific example of the disclosure, regarding which the problem is described in the Summary.

The aspect of the disclosure is described above with reference to the embodiment. The disclosure is, however, not limited to the above embodiment but various modifications and variations may be made to the embodiment without departing from the scope of the disclosure.

### Industrial Applicability

The present disclosure is applicable to industries such as the manufacture of hybrid electric vehicles.

1. A hybrid electric vehicle comprising:
an engine;
a first motor connected to the engine;
a transmission connected to the first motor and to a transfer shaft linked to drive wheels;
a second motor connected to the transfer shaft; and
a controller,
wherein the controller is programmed to control the first and second motors such that, when the vehicle accelerates after decelerating, backlash take-up of a downstream coupling, which is a coupling located on the drive wheels side relative to the transfer shaft, is performed using torque from the second motor, and backlash take-up of an upstream coupling, which is a coupling located on the engine side relative to the transfer shaft, is performed using torque from the first motor.

2. The hybrid electric vehicle according to claim 1,
wherein the second motor is connected to the transfer shaft via a gear mechanism, and
the controller, with torque commands of the first and second motors being Tm1* and Tm2*, respectively; vehicle mass being M; a tire dynamic radius of the drive wheels being R; equivalent inertia from the engine to the transmission being Ipt; gear ratio between the second motor and the transfer shaft being γm2; gear ratio of a differential gear connected to the transfer shaft and the drive wheels being γdf; gear ratio of the transmission being γat; and an allowable amount being α, is programmed to set the torque commands Tm1* and Tm2* to satisfy equation (A) and to control the first and second motors.
$$T m {2}^{⋆} ▯ ym 2 ▯ ydf / ( M ▯ R 2 ) - α < Tm {1}^{⋆} / ( Ipt ▯ yat ▯ ydf ) \qquad ( A )$$

3. The hybrid electric vehicle according to claim 2,
wherein the allowable amount α is determined such that a delay time between the timing of completion of the backlash take-up of the upstream coupling and the timing of completion of the backlash take-up of the downstream coupling is less than or equal to the allowable time.
